(19) United States
(12) Patent Application Publication
(10) Pub. No.: US 2016/0311709 A1
(43) Pub. Date: Oct. 27, 2016

(54) OIL SANDS FLUID FINE TAILINGS DEWATERING USING ADDITIVES

(71) Applicant: SYNCRUDE CANADA LTD. in trust for the owners of the Syncrude Project as such owners exist now and, Fort McMurray (CA)

(72) Inventors: SIMON YUAN, Edmonton (CA); JAMES LORENTZ, Fort McMurray (CA); RON SIMAN, Edmonton (CA); YONG JOE GU, Edmonton (CA)

(21) Appl. No.: 14/885,788

(22) Filed: Oct. 16, 2015

Related U.S. Application Data
(60) Provisional application No. 62/152,429, filed on Apr. 24, 2015.

(51) Int. Cl. C02F 1/52; C02F 1/56

(52) U.S. Cl. CPC C02F 1/5236; C02F 1/56; C02F 2001/007

(57) ABSTRACT

A process of treating and dewatering tailings is provided comprising mixing the tailings with a sufficient amount of a flocculant, a coagulant, or both, to promote flocculation/aggregation of the fine solids in the tailings; mixing a sufficient amount of a hydrophobicity modifying agent with the thus treated tailings to modify the hydrophobicity of the flocculated/aggregated fine solids; and subjecting the resulting mixture to liquid solids separation to yield a solids product for reclamation and a liquid product for recycling or disposal.

### FIELD OF THE INVENTION

The present invention relates generally to a process for dewatering tailings such as oil sands tailings and, more particularly, to improving the dewatering characteristics of flocculated or aggregated tailings by treating the flocculated/aggregated tailings with a hydrophobicity modifying agent (HMA) prior to liquid solids separation.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of fine silts, clays and residual bitumen which have to be contained in a tailings pond. Mineral fractions with a particle diameter less than 44 microns are referred to as “fines.” These fines are typically quartz and clay mineral suspensions, predominantly kaolinite and illite.

The fresh fine tailings suspension is typically 85% water and 15% fine particles by weight. Dewatering of fine tailings occurs very slowly. When first discharged in the pond, the very low density material is referred to as thin fine tailings. After a few years when the fine tailings have reached a solids content of about 30-35 wt %, they are sometimes referred to as mature fine tailings (MFT). Hereinafter, the more general term of fluid fine tailings (FFT) will be used, which encompasses the spectrum of tailings from discharge to final settled state. The fluid fine tailings behave as a fluid colloidal-like material. The fact that fluid fine tailings behave as a fluid and have very slow consolidation rates limits options to reclaim tailings ponds. A challenge facing the industry remains the removal of water from the fluid fine tailings to increase the solids content well beyond 35 wt % and strengthen the deposits to the point that they can be reclaimed and no longer require containment.

Accordingly, there is a need for an improved method of dewatering tailings.

### SUMMARY OF THE INVENTION

The current application is directed to a process for dewatering oil sands tailings by initial treatment of the tailings with a flocculant, a coagulant, or both, followed by treatment with a hydrophobicity modifying agent (HMA). It was surprisingly discovered that by using the process of the present invention, one or more of the following benefits may be realized:

(1) Sequences of chemical additions to tailings in accordance with the present invention may have a profound impact on settling performances. Modifying the tailings properties by addition of a flocculant and/or a coagulant, followed by an HMA, prior to liquid solids separation, such as in a gravity thickener, a hydrocyclone, a centrifuge, a vacuum filter or a filter press, rim ditching (accelerated dewatering), self-weight consolidation, etc. may yield a solids product comprising greater than about 50.0 wt % solids, and a liquid product comprising about 1.0 wt % solids or less.

(2) Addition of flocculants, coagulants, and HMAs to the tailings may have a substantial effect on the tailings, enhancing floc or aggregate particle sizes, hydraulic conductivity and porosity, and changing the hydrophobicity.

(3) Polyacrylamide anionic flocculants having a molecular weight ranging from about 10 to about 24 million and medium charge density (about 25-30%) are more effective than inorganic flocculants.

(4) Cationic polymeric coagulants are more effective than inorganic cationic coagulants at the same dosages. In particular, polymeric coagulants comprising polydimethyldiallylammonium chloride (polyDADMAC) having a molecular weight ranging from about 6,000 to about 1 million and a high charge density (about 100% cationicity) are effective.

(5) The pre-treatment of the tailings with a flocculant, coagulant, or both, and a HMA may accelerate consolidation and dewatering.

(6) Filtration of treated tailings according to the present invention is managed efficiently using a filter press to separate a filter cake suitable for reclamation and a filtrate for recycling or disposal.

Thus, use of the present invention yields a tailings deposit which may become trafficable soon after the liquid solids separation step, and enables reclamation of tailings disposal areas.

Thus, broadly stated, in one aspect of the present invention, a process of treating and dewatering tailings comprising fine solids and water is provided, comprising:
mixing the tailings with an amount of a flocculant, a coagulant, or both, to promote flocculation or aggregation of the fine solids and form a first treated tailings;
mixing an amount of a hydrophobicity modifying agent with the first treated tailings to modify the hydrophobicity of the flocculated/aggregated fine solids and form a second treated tailings; and
subjecting the second treated tailings to liquid solids separation to yield a solids product for reclamation and a liquid product for recycling or disposal.

In one embodiment, the sequence of the flocculant, coagulant, or both, and HMA comprises:
(a) coagulant-HMA;
(b) coagulant-flocculant-HMA;
(c) flocculant-coagulant-HMA;
(d) flocculant-coagulant-flocculant-HMA; or
(e) flocculant-HMA.

In one embodiment, the sequence comprises sequence (a), wherein the coagulant comprises an inorganic coagulant such as polyaluminum, and the HMA comprises dodecylamine.

In one embodiment, the sequence comprises sequence (b), wherein the inorganic coagulant comprises polyaluminum, and the HMA comprises dodecylamine.

In one embodiment, the sequence comprises sequence (c), wherein the flocculant comprises an anionic flocculant, the coagulant comprises a cationic polymeric coagulant, and the HMA comprises dodecylamine.

In one embodiment, the sequence comprises sequence (d) or (e), wherein the flocculant comprises an anionic flocculant, the coagulant comprises a cationic polymeric coagulant, and the HMA comprises dodecylamine.

In one embodiment, the tailings are oil sands tailings. In one embodiment, the tailings are fluid fine tailings derived from oil sands operations.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic of one embodiment of the present invention for dewatering oil sands tailings.

FIG. 2 is a schematic showing an embodiment of the present invention using filtration.

FIG. 3 is a schematic showing an embodiment of the present invention using centrifugation.

FIG. 4 is a schematic showing an embodiment of the present invention using a thickener.

FIG. 5 is a schematic showing an embodiment of the present invention using an accelerated dewatering cell.

FIG. 6 is a schematic showing an in situ embodiment of the present invention.

FIG. 7 is a plot of the solids content in filter cake as a function of time for FFT with no chemicals added (triangles), FFT treated with SNF 3338 (800 g/t) alone (squares) and for FFT treated with SNF 3338 (800 g/t) and DDA (650 g/t) (diamonds) followed by filtration.

FIG. 8 is a graph showing cumulative filtrate volume as a function of time for FFT with no chemicals added (triangles), FFT treated with SNF 3338 (800 g/t) alone (squares) and for FFT treated with SNF 3338 (800 g/t) and DDA (650 g/t) (diamonds) followed by filtration.

FIG. 9 is a graph showing cumulative water recovery as a function of time for FFT with no chemicals added (triangles), FFT treated with SNF 3338 (800 g/t) alone (squares) and for FFT treated with SNF 3338 (800 g/t) and DDA (650 g/t) (diamonds) followed by filtration.

FIG. 10 is a graph showing filtration rates as a function of time for FFT with no chemicals added (triangles), FFT treated with SNF 3338 (800 g/t) alone (squares) and for FFT treated with SNF 3338 (800 g/t) and DDA (650 g/t) (diamonds).

FIG. 11 is a graph showing a comparison of centrifuge cake solids when FFT is treated with SNF 3338 with or without DDA (650 g/t) followed by centrifugation.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

The present invention relates generally to a process for dewatering tailings such as oil sands tailings by treatment with additives in a particular sequence prior to liquid solids separation, such as in a gravity thickener, a hydrocyclone, a centrifuge, a vacuum filter or a filter press (filtration), an accelerated dewatering cell, etc. In particular, the tailings are treated with a flocculant, coagulant, or both, and a hydrophobicity modifying agent (HMA). The process of the invention includes modifying the properties of the oil sands tailings by use of such additives to enhance floc/agglomerate sizes, hydraulic conductivity and porosity, and to change the hydrophobicity. Flocculants and coagulants flocculate/agglomerate particles, thereby affecting the hydraulic conductivity and porosity. Hydrophobicity modifying agents or HMAs are compounds which reduce the affinity between clay and water. The treatment of flocculated or aggregated tailings with such agents accelerates consolidation and dewatering. For example, filtration of tailings treated according to the present invention may yield a filter cake having about 65.0 wt % solids or greater.

As used herein, the term “tailings” means any tailings produced during a mining operation and, in particular, tailings derived from oil sands extraction operations that contain a fines fraction. The term is meant to include fluid fine tailings (FFT) from oil sands tailings ponds and fine tailings from ongoing oil sands extraction operations (for example, flotation tailings, thickener underflow or froth treatment tailings) which may or may not bypass a tailings pond. In one embodiment, the tailings are primarily FFT obtained from oil sands tailings ponds given the significant quantities of such material to reclaim. However, it should be understood that the fine tailings treated according to the process of the present invention are not necessarily obtained from a tailings pond, and may also be obtained from ongoing oil sands extraction operations.

As used herein, the term “flocculation” refers to a process of contact and adhesion whereby the particles of a dispersion form larger-size clusters in the form of flocs or aggregates. As used herein, the term “flocculant” refers to a reagent which promotes flocculation by bridging colloids and other suspended particles in liquids to aggregate, forming a floc. Flocculants useful in the present invention are generally anionic polymers, which may be naturally occurring or synthetic, having relatively high molecular weights. In one embodiment, the dosage of the anionic polymeric flocculant ranges from between about 0 to about 1500 grams per tonne of solids in the tailings.

Suitable natural polymeric flocculants may be polysaccharides such as guar gum, gelatin, alginates, chitosan, and isinglass. Suitable synthetic polymeric flocculants include, but are not limited to, polyacrylamides, for example, a high molecular weight, long-chain modified polyacrylamide (PAM). PAM is a polymer (—CH₂CHCONH₂—)ₙ formed from acrylamide subunits with the following structure:

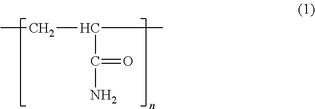

It can be synthesized as a simple linear-chain structure or cross-linked, typically using N,N′-methylenebisacrylamide to form a branched structure. Even though such compounds are often called “polyacrylamide,” many are copolymers of acrylamide and one or more other chemical species, such as an acrylic acid or a salt thereof. The “modified” polymer is thus conferred with a particular ionic character, i.e., changing the anionicity of the PAM. Preferably, the polyacrylamide anionic flocculants are characterized by molecular weights ranging between about 10 to about 24 million, and medium charge density (about 25-30% anionicity).

It will be appreciated by those skilled in the art that various modifications (e.g., branched or straight chain modifications, charge density, molecular weight, dosage) to the flocculant may be contemplated.

As used herein, the term “coagulation” refers to a process of neutralizing repulsive electrostatic charge (often negative) surrounding particles to cause them to collide and agglomerate under the influence of Van der Waals's forces. As used herein, the term “coagulant” refers to a reagent which neutralizes repulsive electrical charges surrounding particles to cause the particles to agglomerate. The term includes organic and inorganic coagulants.

A suitable organic coagulant useful in the present invention includes, but is not limited to, a cationic polymeric coagulant. In one embodiment, the dosage of the cationic polymeric coagulant ranges between about 0 to about 1000 grams per tonne of solids in the tailings. In one embodiment, the cationic polymeric coagulant comprises polydimethyldiallylammonium chloride (or polydiallyldimethylammonium chloride (abbreviated as “polyDADMAC” and having a molecular formula of C₈H₁₆NCl)ₙ). In one embodiment, the polyDADMAC has a molecular weight ranging between about 6,000 to about 1 million, and a high charge density (about 100% cationicity). The monomer DADMAC is formed by reacting two equivalents of allyl chloride with dimethylamine. PoIyDADMAC is then synthesized by radical polymerization of DADMAC with an organic peroxide used as a catalyst. Two polymeric structures are possible when polymerizing DADMAC: N-substituted piperidine structure or N-substituted pyrrolidine structure, with the pyrrolidine structure being favored. The polymerization process for polyDADMAC is shown as follows:

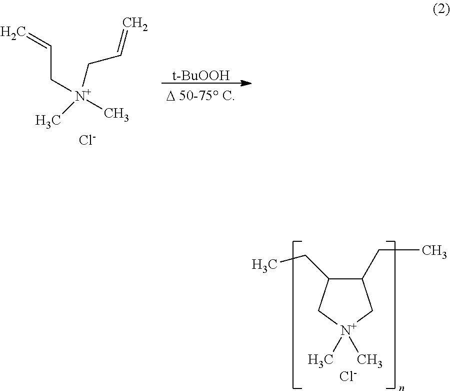

In one embodiment, cationic polymeric coagulants are more effective than inorganic cationic coagulants at the same dosages. However, suitable inorganic cationic coagulants useful in the present invention include, but are not limited to, alum, aluminum chlorohydrate, aluminum sulphate, lime (calcium oxide), slaked lime (calcium hydroxide), calcium chloride, magnesium chloride, iron (II) sulphate (ferrous sulphate), iron (III) chloride (ferric chloride), sodium aluminate, gypsum (calcium sulfate dehydrate), or any combination thereof. In one embodiment, the inorganic coagulants include multivalent cations. As used herein, the term “multivalent” means an element having more than one valence. Valence is defined as the number of valence bonds formed by a given atom. Suitable multivalent inorganic coagulants may comprise divalent or trivalent cations. Divalent cations increase the adhesion of bitumen to clay particles and the coagulation of clay particles, and include, but are not limited to, calcium (Ca²⁺), magnesium (Mg²⁺), and iron (Fe²⁺). Trivalent cations include, but are not limited to, aluminium (Al³⁺), iron (Fe³⁺).

As used herein, “aggregation” refers to the formation of clusters, flocs or aggregates in a colloidal suspension as a result of the addition of a flocculant, a coagulant, or both. Aggregation is also referred to herein as coagulation or flocculation.

As used herein, the term “hydrophobicity modifying agent” or “HMA” refers to a reagent which increases the natural hydrophobicity of a mineral surface, thereby decreasing the mineral's affinity to water. For example, such reagents can adsorb physically onto mineral surfaces that possess active sites having strong negative charge, thereby rendering the mineral surfaces less water loving (hydrophilic) and more water repelling (hydrophobic). A suitable HMA is a cationic collector such as dodecylamine (DDA) having a molecular weight of about 185 Da and molecular formula of C₁₂H₂₇N. The other cationic collectors suitable for clay minerals include, but are not limited to, DDAHCI (dodecylamine hydrochloride, MW=221.81); DTAC (dodecyl-trimethylammonium chloride, MW=263.89); CTAB (cetyl-trimethylammonium bromide, MW=364.45).

In the present invention, flocculation/aggregation of tailings is followed by treatment with an HMA. Without being bound by any theory, treatment of the flocculated/aggregated tailings with an HMA enhances the particle surface hydrophobicity, thereby reducing the affinity of the aggregates to retain water and increasing the hydraulic conductivity of the aggregates. This results in better solids liquid separation and a product which becomes more rapidly reclaimable.

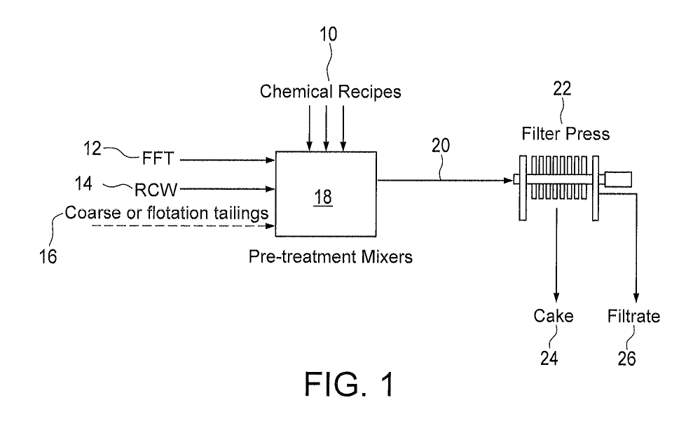

A general schematic of the present invention is shown in FIG. 1, wherein filtration is used as an example of a solids liquid separation method useful in the present invention. A sufficient amount of additives 10 are added in a particular sequence to the tailings 12. In one embodiment, the tailings 12 are diluted with water 14 prior to treatment with the additive 12 or mixture thereof. In one embodiment, the feed sand to fine ratio of the tailings is adjusted prior to treatment with the additive 10 or mixture thereof. For example, coarse and/or flotation tailings 16 may be added to tailings 12 to adjust the feed sand to fine ratio.

In one embodiment, the additives 10 are combined with the tailings 12 in a mixer 18. Suitable additive introduction can include, but are not limited to, dynamic mixers, T mixers, static mixers, and continuous-flow stirred-tank reactors. Preferably, the mixer is a dynamic mixer in order to better optimize the additives/tailings interaction. A typical dynamic mixer is powered by an electric motor and contains one or more mixing elements which perform a rotary motion about the axis of the flow path. The speed and configuration of the mixing elements can be easily modified to fine-tune the mixing process for products which are susceptible to variations in raw material. In one embodiment, the additives 10 are introduced into an in-line flow of the tailings. As used herein, the term “in-line flow” means a flow contained within a continuous fluid transportation line such as a pipe or another fluid transport structure which preferably has an enclosed tubular construction. Mixing is conducted for a sufficient duration in order to allow the tailings 12 and additives 10 to combine properly and to ensure the efficiency of the additives.

The preferred additives may be selected according to the tailings composition and process conditions. However, optimum sequences of specific additives have been identified for the effective dewatering of tailings and production of a suitable filter cake for reclamation and water amenable for recycling or disposal. Suitable additives include, but are not limited to, flocculants, coagulants, or both flocculants and coagulants, and an HMA.

In one embodiment, the sequence of the flocculants, coagulants, or both, and HMAs comprises a sequence selected from:
(a) coagulant-HMA;
(b) coagulant-flocculant-HMA;
(c) flocculant-coagulant-HMA;
(d) flocculant-coagulant-flocculant-HMA; or
(e) flocculant-HMA.

In one embodiment, the sequence comprises the sequence (a), wherein the coagulant comprises polyaluminum, and the HMA comprises dodecylamine.

In one embodiment, the sequence comprises the sequence (b), wherein the coagulant comprises polyaluminum, the flocculant comprises an anionic polymer and the HMA comprises dodecylamine.

In one embodiment, the sequence comprises the sequence (c), wherein the flocculant comprises an anionic flocculant, the coagulant comprises a cationic polymeric coagulant, and the HMA comprises dodecylamine.

In one embodiment, the sequence comprises the sequence (d) or (e), wherein the flocculant comprises an anionic flocculant, the coagulant comprises a cationic polymeric coagulant, and the HMA comprises dodecylamine.

Following mixing for a sufficient duration in order to allow the tailings and flocculants, coagulants, or both, and HMA to combine properly in sequence, the treated oil sands fine tailings 20 are removed from the mixer 18, and subjected to liquid solids separation, for example, filtration. In one embodiment, filtration is conducted using a filter press 22 to yield a filter cake 24 and filtrate 26.

The operation of filter presses is commonly known to those skilled in the art and will not be discussed in detail. Briefly, a filter press separates liquids and solids by forcing the liquid fraction of a feed slurry through a permeable filter cloth. The separation takes place in chambers formed between the recessed faces of plates, which have been clamped together in a rugged steel frame. The molded filter plates are formed with corrugated drainage surfaces in the chamber recesses and ports for slurry feed and filtrate drainage. Each face is covered with a filter cloth and the plates are clamped together using a hydraulic ram. Slurry is pumped in under high pressure, filling the chambers with solids and pushing liquid out through the filter cloth. When no more solids can be forced into chambers, the feed pumps are turned off and compressed air is used to remove interstitial water from pores in the filter cake. When the desired residual moisture content has been achieved, the filter is opened, the filter cake is removed.

In one embodiment, the filter press filters the pre-treated oil sands tailings 20 at a pressure of about 15.5 bar (225 psi) or less. The pre-treatment of the tailings accelerates consolidation and dewatering. In one embodiment, filtration of the pre-treated tailing yields a filter cake comprising greater than about 65.0 wt % solids or greater. The filter cake may be used directly for reclamation, and readily transported by conveyor belts, mobile stackers, and/or trucks to storage. The filtrate comprises about 1.0 wt % solids or less, and is amenable for recycling for FFT dilution or disposal in a tailings pond.

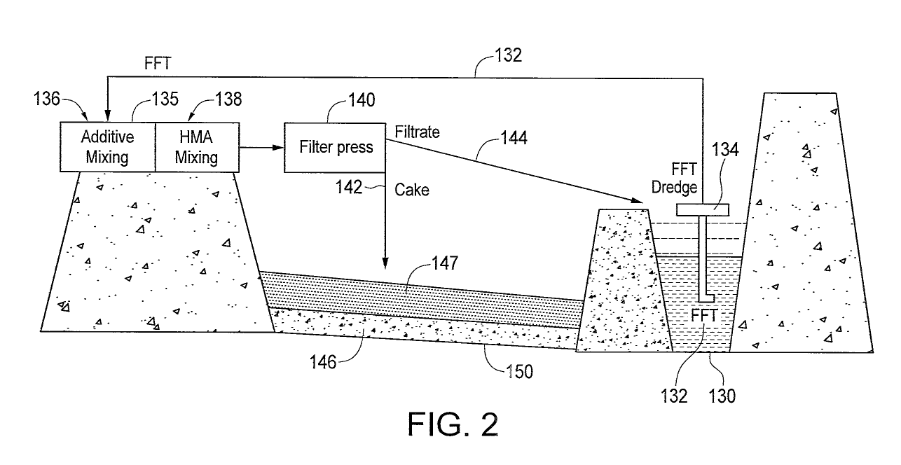

FIG. 2 shows a flow sheet of one embodiment of the present invention. In this embodiment, fluid fine tailings (FFT) 132 can be dredged from existing tailings ponds 130 using dredging equipment 134 known in the art, The dredged FFT 132 can be pumped to at least one mixer 135 wherein an additive 136 such as a flocculant, coagulant or both can be added, mixed, followed by addition of a HMA 138 such as dodecylamine (DDA), dodecylamine hydrochloride (DDAHCI); dodecyl-trimethylammonium chloride (DTAC); cetyl-trimethylammonium bromide (CTAB), and further mixed. The thus-treated FFT can then be subjected to filtration in, for example, a filter press 140 where a substantially clean filtrate 144 is formed which can be reused (e.g., in an oil sand extraction operation) or disposed of into tailings pond 130 for later reuse. The filter cake 142 can be deposed in a cell 150 or the like, preferably having a sloped bottom, for further dewatering. As shown herein, cell 150 comprises a layer of sand 146 to aid in drainage of water. A substantially solid layer 147 thus forms at the bottom of the cell 150. Once layer 147 is substantially dewatered, additional filter cake layers can be placed on top of a previously dewatered filter cake layer.

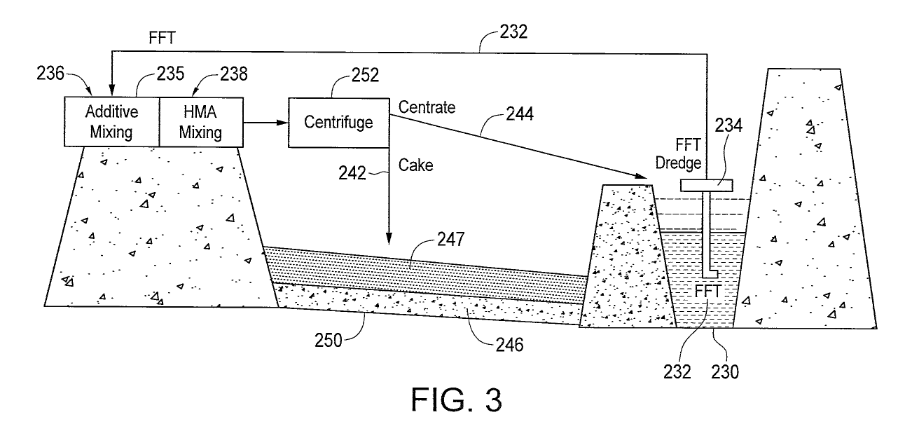

FIG. 3 shows another embodiment of the present invention. In this embodiment, fluid fine tailings (FFT) 232 can be dredged from existing tailings ponds 230 using dredging equipment 234 known in the art. The dredged FFT 232 can be pumped to at least one mixer 235 wherein an additive 236 such as a flocculant, coagulant or both can be added, mixed, followed by addition of a HMA 238 such as dodecylamine (DDA), dodecylamine hydrochloride (DDAHCI.); dodecyl-trimethylammonium chloride (DTAC); cetyl-trimethylammonium bromide (CTAB), and further mixed. The thus-treated FFT can then be subjected to centrifugation in a centrifuge 252 where a substantially clean centrate 244 is formed which can be reused or disposed of into tailings pond 230 for reuse. The centrifuge cake 242 can be deposed in a cell 250 or the like, preferably having a sloped bottom, for further dewatering. As shown herein, cell 250 comprises a layer of sand 246 to aid in drainage of water. A substantially solid layer 247 forms at the bottom of the cell 250. Once layer 247 is substantially dewatered, additional centrifuge cake layers can be placed on top of a previously dewatered centrifuge cake layer.

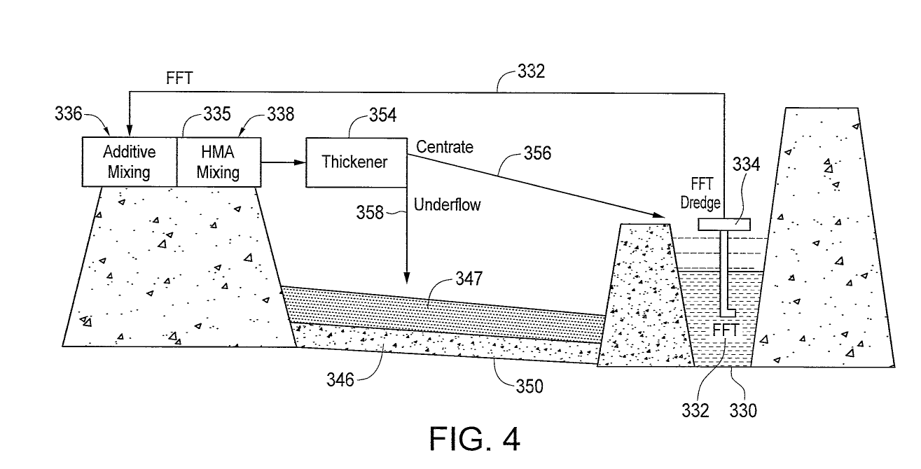

FIG. 4 shows another embodiment of the present invention. In this embodiment, fluid fine tailings (FFT) 332 can be dredged from existing tailings ponds 330 using dredging equipment 334 known in the art. The dredged FFT 332 can be pumped to at least one mixer 335 wherein an additive 336 such as a flocculant, coagulant or both can be added, mixed, followed by addition of a HMA 338 such as dodecylamine (DDA), dodecylamine hydrochloride (DDAHCI); dodecyl-trimethylammonium chloride (DTAC); cetyl-trimethylammonium bromide (CTAB), and further mixed. The thus-treated FFT can then be added to a thickener 354 wherein the flocs will settle to the thickener bottom. As the flocs settle, water will be released therefrom and removed as overflow 356. The overflow 356 can be reused or disposed of into tailings pond 330 for reuse. The settled flocs or underflow 358 can be deposed in a cell 350 or the like, preferably having a sloped bottom, for further dewatering. As shown herein, cell 350 comprises a layer of sand 346 to aid in drainage of water. A substantially solid layer 347 forms at the bottom of the cell 350. Once layer 347 is substantially dewatered, additional underflow layers can be placed on top of a previously dewatered underflow layer.

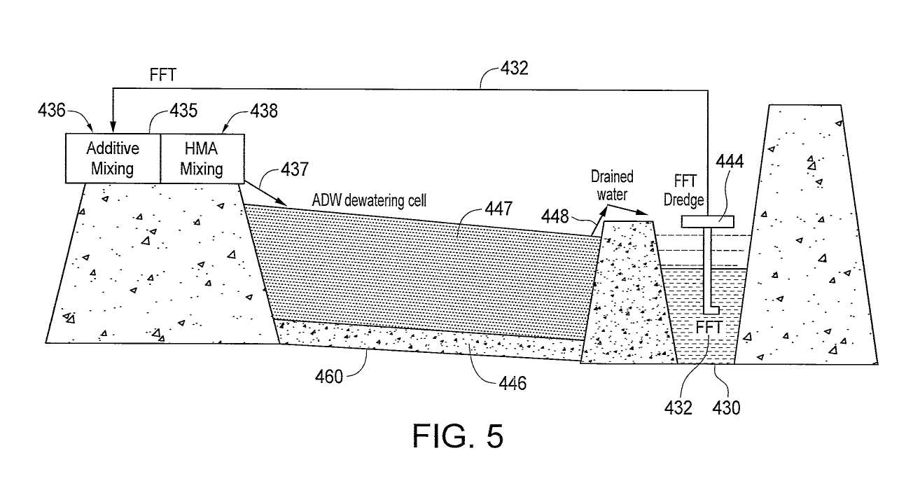

FIG. 5 shows another embodiment of the present invention. In this embodiment, fluid fine tailings (FFT) 432 can be dredged from existing tailings ponds 430 using dredging equipment 434 known in the art. The dredged FFT 432 can be pumped to at least one mixer 435 wherein an additive 436 such as a flocculant, coagulant or both can be added, mixed, followed by addition of a HMA 438 such as dodecylamine (DDA), dodecylamine hydrochloride (DDAHCI); dodecyl-trimethylammonium chloride (DTAC); cetyl-trimethylammonium bromide (CTAB), and further mixed. The thus-treated FFT can then be deposited in a specialized accelerated dewatering cell 460 such as a rim ditch. Rim ditching is a common method of accelerating the dewatering of tailings, whereby the degree of saturation is controlled by preventing standing water from accumulating on the tailings deposit. Thus, released water 448 is continuously drained or removed. The pressure of the material above helps to squeeze water out of the deposit 447. When enough strength is reached, a continuous ditch may be created around the edge of the deposit to allow for accumulation of the water pushed from the pore spaces. With extensive deposit cracking and the construction of a ditch to collect water and guide it to a collection sump, tailings dewatering can be enhanced. The more rapidly strength develops in the tailings deposit, the more quickly and deeply the rim ditch can be constructed.

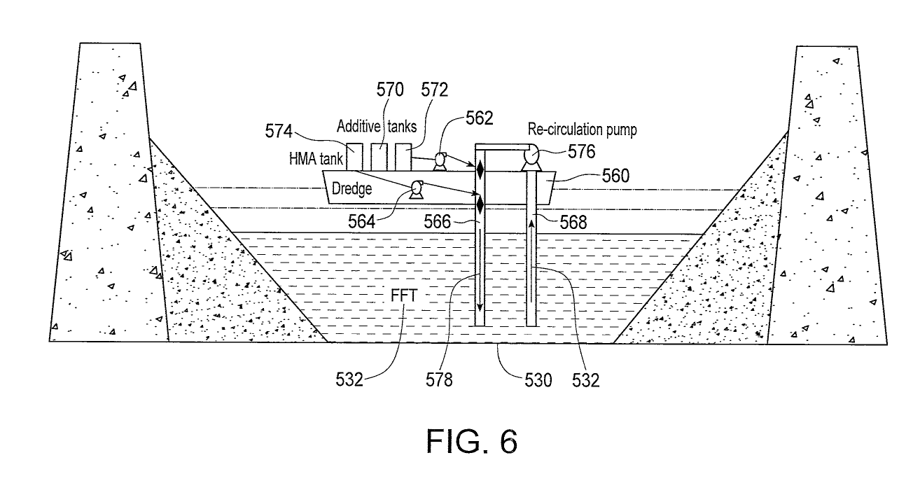

FIG. 6 is a schematic showing an in situ application of the present invention. In particular, a dredging barge 560 is situated on top of an existing tailings pond 530 and is equipped to dredge fluid fine tailings (FFT) 532 through first pipe 568 via re-circulation pump 576. First pipe 568 is operably connected to a second pipe 566. The FFT is first treated by adding at least one additive, for example a flocculant which is stored in flocculant tank 572, a coagulant which is stored in coagulant tank 570, or both. Tanks 570, 572 can be located on the dredging barge itself and the chemicals may be prepared either on or off shore. The at least one additive is pumped from its respective tank and added at or near the top of second pipe 566. A hydrophobic modifying agent, such as dodecylamine (DDA), dodecylamine hydrochloride (DDAHCI); dodecyl-trimethylammonium chloride (DTAC); cetyl-trimethylammonium bromide (CTAB), is then added from HMA tank 574 via pump 564 to second pipe 566 after the addition of the at least one additive from additive tanks. The treated FFT 578 is then expelled from the bottom of second pipe 566, which is also located in tailings pond 530.

Second pipe 566 is of a sufficient length that mixing of the at least one additive and FFT and mixing of the flocculated/aggregated FFT with a HMA will occur in the pipe. However, it is understood that in-line static mixers or dynamic mixers can also be installed for enhanced mixing.

Without being bound by any theory, the effects of using the additives in particular sequences upon the dewatering rate may be explained by Darcy's law which is expressed as follows:

$$\begin{matrix}\frac{d V}{d t} = Q = K \frac{A Δ P}{η L} and K = \frac{{ɛ}^{3}}{{{kS}^{2} ( 1 - ɛ )}^{2}} & ( 3 )\end{matrix}$$

where Q=dewatering rate; V=volume of water; t=time; K=rate constant; A=filter area; ΔP=pressure drop; η=kinematic viscosity of water; L=cake thickness; ε=cake porosity or volume fraction of particles in the cake; S=surface area of all particles of the cake; k=Kozney constant; d=particle diameter.

$$\begin{matrix}Darcy ' s Law \text{:} dewatering rate & \\ \frac{d V}{d t} = Q = K \frac{A Δ P}{η L} and K = \frac{{ɛ}^{3}}{{{kS}^{ 2} ( 1 - ɛ )}^{2}} & ( 4 ) \\ {P}_{c} = \frac{2 γ cos θ}{R} and Δ P = {P}_{app} - {P}_{c} & \end{matrix}$$

where P_{c}=capillary pressure; θ=contact angle of water; γ=surface tension of water; R=capillary radius; Pₐₚₚ=applied pressure.

For example, if the particle diameter is decreased from 10 μm to 1 μm, the surface area of all particles of the cake increases by 100 times, while the rate constant K and dewatering rate Q decrease by 10,000 times. Enlarging particle size using a combination of flocculants and coagulants contributes to rapid dewatering. If the contact angle is increased by increasing the surface hydrophobicity, the surface tension is reduced, and/or the capillary radius is increased, the capillary pressure may be reduced. The pressure drop is increased for a given applied pressure. The dewatering rate accordingly increases.

Exemplary embodiments of the present invention are described in the following Examples, which are set forth to aid in the understanding of the invention, and should not be construed to limit in any way the scope of the invention as defined in the claims which follow thereafter. In the following Examples, the liquid solids separation process involves the use of a filter press. It is understood, however, that other liquid solids separation processes can be used,

### EXAMPLE 1

In this example, the chemical addition sequence for treating tailings tested was flocculant followed by a HMA. As controls, the FFT was either untreated or treated with flocculant only. The tailings used in this example were FFT comprising about 20 wt % solids. The flocculant used in this example was an anionic, high molecular weight polyacrylamide, which is commercially available as SNF 3338.

In a mixing tank, the FFT was first treated with 800 g flocculant per tonne of tailings solids and mixed for 30 seconds to form large aggregates (i.e., flocs). The flocculated/aggregated FFT was then treated with a HMA, in this instance, dodecylamine (DDA), at a dosage of 650 g/tonne of tailings solids and mixed for a further 30 seconds, to enhance the hydrophobicity of the flocs/aggregates. The mixing tank used was a 125 mm SS tank with a FBT impeller having an ID of 87.5 mm. The mixing speed used was 250 rpm.

Following flocculant/HMA treatment, the treated FFT is transferred to a filter press and filtered to provide a filter cake and a filtrate. Filtration was conducted in an Ertelalsop LAB-43TJ filter and the filter cylinder ID was 17.5 cm. The filter media used was Die 81. The pressure use was 20 psi and the filtration time was 1 hr and 15 min. Table 1 below summarizes the results after 75 minutes of filtration under 20 psi pressure.

TABLE 1

| | Condition | | | | | |
|---|---|---|---|---|---|---|
| | SNF 3338 800 g/t | | SNF 3338 800 | | | |
| | DDA 650 g/t | | g/t alone | | No chemicals added | |
| | Wet | | Wet | | Wet | |
| Product | wt. g | Solids % | wt. g | Solids % | wt. g | Solids % |
| Cake | 313 | 64.93% | 1081 | 22.00% | 1057 | 22.54% |
| Filtrate | 605 | 0.20% | 156 | 0.20% | 134 | 0.20% |
| Feed | 918 | 22.26% | 1237 | 19.23% | 1191 | 20.00% |

It can be seen that with no chemical treatment, i.e., no flocculant or HMA added, FFT filtration resulted in a filter cake having only a marginal increase in solids content (i.e., 22.54 wt %). With flocculant (SNF 3338 800 g/t) treatment alone, the solids content of the filter cake was also only marginally increased (i.e., 22.00 wt %). However, when FFT was treated with flocculant (SNF 3338 800 g/t) followed by treatment with a HMA (DDA 650 g/t), the filter cake produced had a solids content of 64.93 wt %.

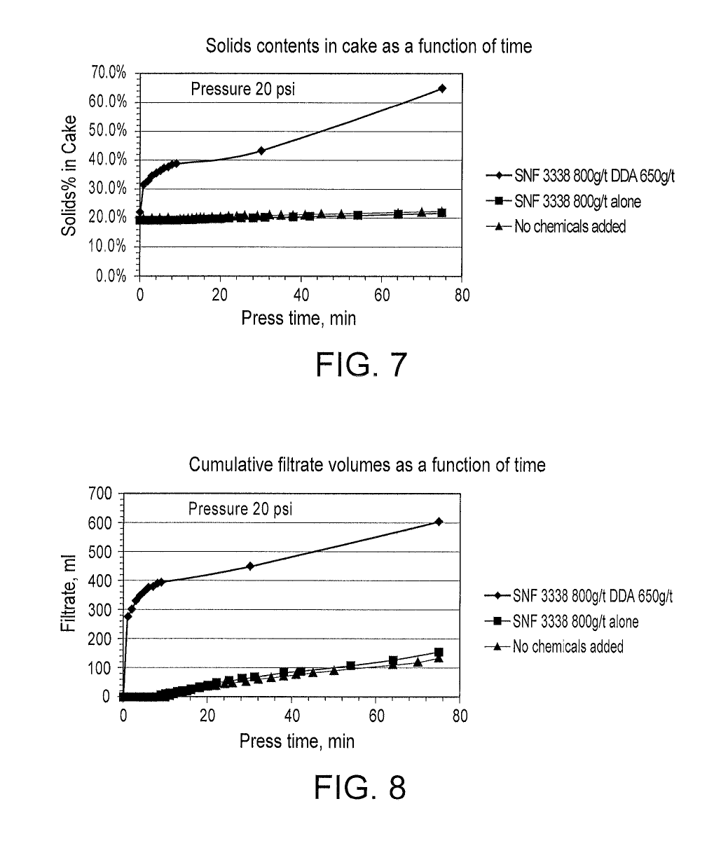

FIG. 7 is a plot of the solids content in filter cake as a function of time for FFT with no chemicals added (triangles), FFT treated with SNF 3338 (800 g/t) alone and for FFT treated with SNF 338 (800 g/t) and DDA (650 g/t). It can be seen in FIG. 3 that the solids content (wt %) in the filter cake only increased significantly when the FFT was treated with both a flocculant and a HMA. Without being bound by any theory, it is believed that treatment of the FFT with flocculant/HMA enhances the particle surface hydrophobicity, thereby reducing the affinity of the aggregates to retain water and increasing the hydraulic conductivity of the aggregates. Filtration efficiency is thereby enhanced.

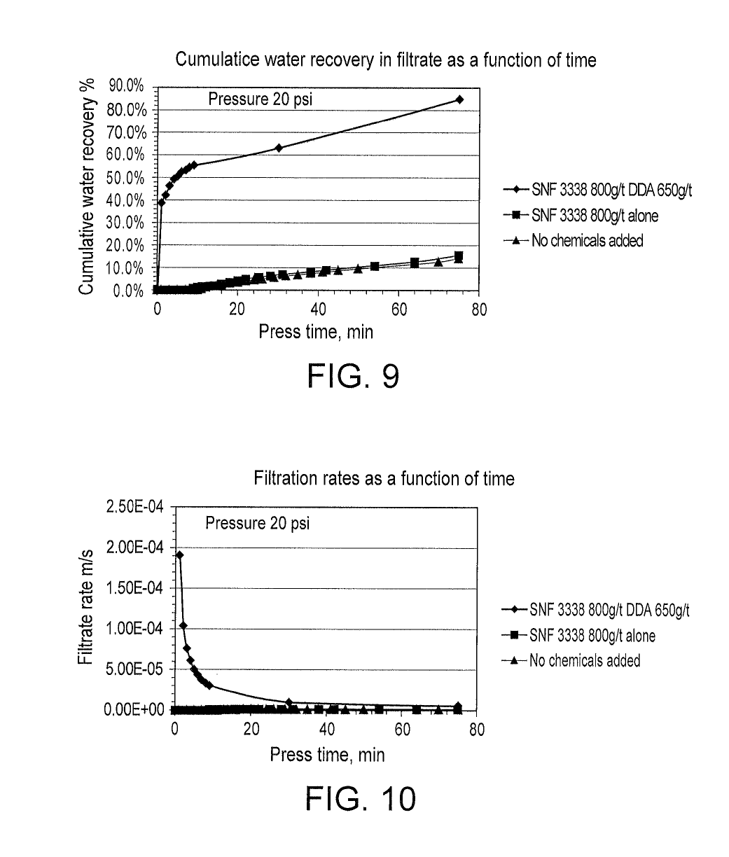

FIG. 8 is a graph showing cumulative filtrate volume as a function of time for FFT with no chemicals added (triangles), FFT treated with SNF 3338 (800 g/t) alone (squares) and for FFT treated with SNF 3338 (800 g/t) and DDA (650 g/t) (diamonds). It can be seen that the volume of filtrate almost immediately increased with the FFT treated with SNF 3338 (800 g/t) and DDA (650 g/t) as opposed to untreated FFT or FFT treated with flocculant only. Similarly, FIG. 9 shows the cumulative water recovery as a function of time for FFT with no chemicals added (triangles), FFT treated with SNF 3338 (800 g/t) alone (squares) and for FFT treated with SNF 3338 (800 g/t) and DDA (650 g/t) (diamonds). Once again, the FFT treated with SNF 3338 (800 g/t) and DDA (650 g/t) showed 40.0% water recovery almost immediately after filtration commenced, with an 85% recovery of water by 75 minutes. The filtration rate for FFT without any chemical addition is very slow.

Finally, FIG. 10 is a graph showing filtration rates as a function of time for FFT with no chemicals added (triangles), FFT treated with SNF 3338 (800 g/t) alone (squares) and for FFT treated with SNF 3338 (800 g/t) and DDA (650 g/t) (diamonds). The results show that even under relatively low pressure of 20 psi, the filtration rate is very fast when DDA of 650 g/t is used to modify the surface hydrophobicity of the flocculated materials. At the filter cake 65 wt % solids (i.e., void ration 1.43), the filtration rate is still 5.6×10⁻⁶ m/s, which is much faster than FFT hydraulic conductivity of 1×10⁻⁹ m/s at the same void ratio.

### EXAMPLE 2

In this example, the chemical addition sequence for treating tailings was either flocculant alone or flocculant followed by a HMA. However, instead of subjecting treated tailings to filtration, treated tailings were subjected to centrifugation. The tailings used in this example were FFT comprising about 20-35 wt % solids or FFT comprising about 38.66 wt % solids. The flocculant used was an anionic, high molecular weight polyacrylamide, which is commercially available as SNF 3338. The HMA was dodecylamine (DDA).

In a mixing tank, the FFT was treated with 800 g or 1000 g flocculant (SNF 3338) per tonne of tailings solids and mixed for 30 seconds to form large aggregates (i.e., flocs). The flocculated/aggregated FFT was then either treated with DDA at a dosage of 650 g/tonne of tailings solids or no further treatment was performed. When treated with DDA, the FFT flocculated/aggregated tailings were mixed for a further 30 seconds, to enhance the hydrophobicity of the flocs/aggregates. Several different mix conditions were tested, in particular, various H/T conditions were used, i.e., where H/T is the ratio of the slurry (tailings) height in the tank and the tank diameter. The mixing speed was also varied (250 rpm, 280 rpm or 300 rpm).

The dewatering capability of treated FFT was measured using a Triton Electronics Ltd. Capillary Suction Time tester to correlate dewatering efficiency with the chemical addition sequence. Dewaterability is measured as a function of how long it takes for water to travel radially between two ring electrodes through a filter and low values indicate rapid dewatering whereas high values indicate slow dewatering ability. Thus, a relatively low average capillary suction time (CST, seconds) indicates good dewatering. The centrifuge cake solids and centrate solids were also measured. The results are shown in Table 2 below.

TABLE 2

| Test # | Date | Feed solids % | Mix conditions | Flocculant | HMA | CST (sec) Ave | Cake solids % | Centrate solids % |
|---|---|---|---|---|---|---|---|---|
| 79a | 21-Jul- | 20% | H/T = 0.65, 250 rpm | SNF 3338, 800 g/t | None | 29 | 39.18% | 0.33% |
| 80a | 21-Jul- | 25% | H/T = 0.65, 250 rpm | SNF 3338, 800 g/t | None | 31 | 45.82% | 0.33% |
| 81a | 21-Jul- | 30% | H/T = 0.65, 280 rpm | SNF 3338, 800 g/t | None | 124 | 46.46% | 0.31% |
| 82a | 21-Jul- | 35% | H/T = 0.65, 300 rpm | SNF 3338, 800 g/t | None | 88 | 44.51% | 0.24% |
| 86a | 23-Jul- | 38.66% | H/T = 0.4, 250 rpm | SNF 3338, 1000 g/t | None | 920 | 42.06% | 0.39% |
| 79b | 21-Jul- | 20% | H/T = 0.65, 250 rpm | SNF 3338, 800 g/t | DDA 650 g/t | 22 | 49.81% | 0.28% |
| 80b | 21-Jul- | 25% | H/T = 0.65, 250 rpm | SNF 3338, 800 g/t | DDA 650 g/t | 20 | 53.16% | 0.22% |
| 81b | 21-Jul- | 30% | H/T = 0.65, 280 rpm | SNF 3338, 800 g/t | DDA 650 g/t | 26 | 51.51% | 0.28% |
| 82b | 21-Jul- | 35% | H/T = 0.65, 300 rpm | SNF 3338, 800 g/t | DDA 650 g/t | 50 | 49.56% | 0.34% |
| 86b | 23-Jul- | 38.66% | H/T = 0.4, 250 rpm | SNF 3338, 1000 g/t | DDA 650 g/t | 21 | 51.87% | 0.27% |

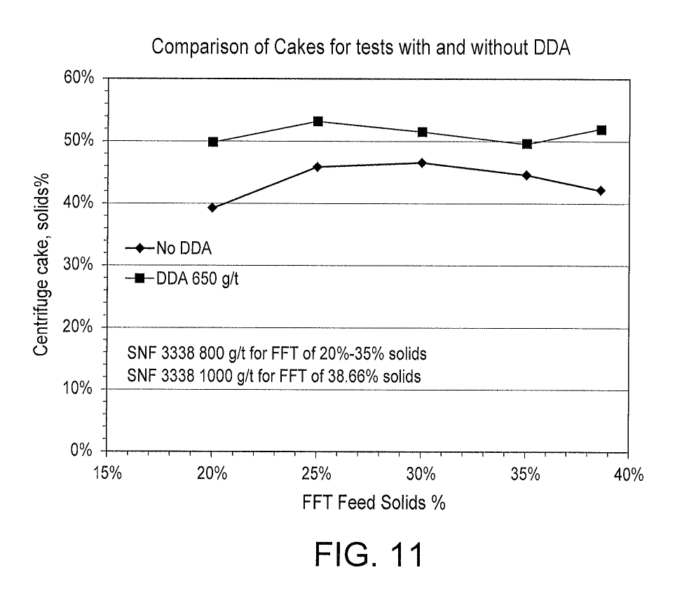

It can be seen from the results in Table 2 that, on average, treatment of FFT with a flocculant followed by treatment with a HMA resulted in higher solids in the centrifuge cake (between about 50 wt % to about 53 wt %) than treatment with flocculant alone (between about 39 wt % to about 46.5 wt %). Furthermore, the capillary suction times (CST, seconds) were generally significantly lower when treating FFT with both flocculant and a HMA, indicating better dewatering capability. These results can also be seen in FIG. 11. Thus, it can be seen that under the same conditions, the centrifuge cake solids contents for FFT treated with SNF 3338 and DDA are about 5-10% higher than those treated with SNF 3338 alone.

### EXAMPLE 3

A chemical addition sequence for treating fluid fine tailings (FFT) comprises an inorganic coagulant and an HMA. In a mixing tank, the FFT is first treated with an inorganic coagulant (for example, polyaluminum) to agglomerate fine particles to yield larger-size aggregates. The FFT is then treated with an HMA (for example, dodecylamine) to enhance the hydrophobicity of the aggregates. Following treatment, the FFT is transferred to a filter press, and filtered to separate the resultant filter cake and filtrate. Without being bound by any theory, treatment of the larger-size aggregates with an HMA enhances the surface hydrophobicity of the aggregates, thereby reducing the affinity of the aggregates to retain water and increasing the hydraulic conductivity of the aggregates. Filtration efficiency is thereby enhanced.

### EXAMPLE 4

A chemical addition sequence for treating FFT comprises an inorganic coagulant, a flocculant, and an HMA. In a mixing tank, the FFT is first treated with an inorganic coagulant (for example, polyaluminum) to agglomerate fine particles to yield larger-size aggregates. The FFT is then treated with a flocculant to bind the aggregates to form even larger aggregates (i.e., flocs). The FFT is lastly treated with an HMA (for example, dodecylamine) to enhance the hydrophobicity of the hydrophobicity of the aggregates. Following treatment, the FFT is transferred to a filter press, and filtered to separate the resultant filter cake and filtrate. Without being bound by any theory, treatment of the FFT enhances the particle surface hydrophobicity, thereby reducing the affinity of the aggregates to retain water and increasing the hydraulic conductivity of the aggregates. Filtration efficiency is thereby enhanced.

### EXAMPLE 5

A chemical addition sequence for treating FFT comprises a flocculant, a coagulant, and an HMA. In a mixing tank, the FFT is first treated with a flocculant (for example, an anionic flocculant) to bridge the majority of the particles to form large aggregates (i.e., flocs). The FFT is then treated with a coagulant (for example, a cationic polymeric coagulant) to capture extremely fine particles that are not flocculated to yield larger-size aggregates. The FFT is lastly treated with an HMA (for example, dodecylamine) to enhance the hydrophobicity of the flocs/aggregates. Following treatment, the FFT is transferred to a filter press, and filtered to separate the resultant filter cake and filtrate. Without being bound by any theory, treatment of the FFT enhances the particle surface hydrophobicity, thereby reducing the affinity of the aggregates to retain water and increasing the hydraulic conductivity of the aggregates. Filtration efficiency is thereby enhanced.

### EXAMPLE 6

A chemical addition sequence for treating FFT comprises a flocculant, a coagulant, a flocculant, and an HMA. In a mixing tank, the FFT is first treated with a flocculant (for example, an anionic flocculant) to bridge the majority of the particles to form large aggregates (i.e., flocs). The FFT is then treated with a coagulant (for example, a cationic polymeric coagulant) to capture extremely fine particles that are not flocculated to yield larger-size aggregates. The FFT is then treated with a flocculant to bind the flocs/aggregates together to form even larger aggregates/flocs. The FFT is finally treated with an HMA (for example, dodecylamine) to enhance the hydrophobicity of the flocs. Following treatment, the FFT is transferred to a filter press, and filtered to separate the resultant filter cake and filtrate. Without being bound by any theory, treatment of the FFT enhances the particle surface hydrophobicity, thereby reducing the affinity of the aggregates to retain water and increasing the hydraulic conductivity of the aggregates. Filtration efficiency is thereby enhanced.

### EXAMPLE 7

A chemical addition sequence for treating FFT comprises a flocculant and an HMA. In a mixing tank, the FFT is first treated with a flocculant (for example, an anionic flocculant) to form large aggregates (i.e., flocs). The FFT is then treated with an HMA (for example, dodecylamine) to enhance the hydrophobicity of the flocs/aggregates. Following treatment, the FFT is transferred to a filter press, and filtered to separate the resultant filter cake and filtrate. Without being bound by any theory, treatment of the FFT enhances the particle surface hydrophobicity, thereby reducing the affinity of the aggregates to retain water and increasing the hydraulic conductivity of the aggregates. Filtration efficiency is thereby enhanced.

From the foregoing description, one skilled in the art can easily ascertain the essential characteristics of this invention and adapt it to various usages and conditions. Reference to an element in the singular, such as by use of the article “a” or “an” is not intended to mean “one and only one” unless specifically so stated, but rather “one or more”. Nothing disclosed herein is intended to be dedicated to the public regardless of whether such disclosure is explicitly recited in the claims.

### REFERENCES

All publications mentioned herein are incorporated herein by reference (where permitted) to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

Avery, Q. and Wilson, K. (2013) Red mud pressure filtration for the alumina refinery's bauxite residue tailings disposal. Proceedings of Paste 2013: the 16^{th} International Serminar on Paste and Thickened Tailings (Eds. R. Jewell, A. Fourie, J. Caldwell and J. Pimenta). Jun. 17-20, 2013, Bello Horizonte, Brazil, p. 225-238.

Cote, C., Sibbel, K., Heffel, R., Cafferata, K., Chengara, A., Duttlinger, W. and Knauer, J. (2013) Mature fine tailings treatment using inline flocculation and filtration. Proceedings of Tailings and Mine Waste 2013, Nov. 3-6, 2013, Banff, Alberta, Canada, p. 203-212.

Duttliner Jr., W. T.; Chengara. A., Cross, K. J. and Sommese, A. G. (2013) Process and system for dewatering oil sands fine tailings. United States Patent Application Publication No. US 2014/0054232, published Feb. 27, 2014.

Yoon, R. H., Eraydin, K. and Freeland, C. (2011) Cleaning and dewatering fine coal. Canadian Patent Application No. 2,789,218, published Aug. 4, 2011.

Yuan, X. S. and Shaw, W. (2006) Novel processes for treatment of Syncrude fine transition and marine ore tailings. Interfacial Phenomena in Fine Particle Technology, Z. Xu and Q. Liu (eds.), the 45^{th} Annual Conference of Metallurgists of CIM, Oct. 1-4, 2006, Montreal, Quebec, Canada, pp. 477-491.

Yuan, X. S. and Shaw, W. (2007) Novel processes for treatment of Syncrude fine transition and marine ore tailings, Canadian Metallurgical Quarterly, Vol. 46, No., 3, pp. 265-272.

Yuan, X. S. (2011) Ore types impact on flocculation and the treatment strategies for different types of oil sand tailings, Proceedings of Paste 2011: 14^{th} International Seminar on Paste and Thickened Tailings, R. Jewell and A. B., Fourie (eds.), 5-7 April, Perth, Australia. Australian Centre for Geomechanics, Perth, pp. 143-154.

1. A process of treating and dewatering tailings comprising fine solids and water, comprising:
(a) mixing the tailings with an amount of a flocculant, a coagulant, or both, to promote flocculation/aggregation of the fine solids in the tailings and form a first treated tailings;
(b) mixing an amount of a hydrophobicity modifying agent with the first treated tailings to modify the hydrophobicity of the flocculated/aggregated fine solids and form a second treated tailings; and
(c) subjecting the second treated tailings to liquid solids separation to yield a solids product for reclamation and a liquid product for recycling or disposal.

2. The process of claim 1, wherein the tailings are diluted with water prior to treatment.

3. The process of claim 1, wherein sand is added to the tailings to adjust the sand to fine solids ratio of the tailings prior to treatment.

4. The process of claim 1, wherein mixing steps (a) and (b) take place within a mixing vessel.

5. The process of claim 1, wherein the flocculant, coagulant, or both, and the hydrophobicity modifying agent are combined with the tailings at one or more in-line treatment points under conditions conducive to proper mixing.

6. The process of claim 1, wherein
an inorganic coagulant is used in step (a).

7. The process of claim 6, wherein the inorganic coagulant comprises polyaluminum, and the hydrophobicity modifying agent comprises dodecylamine.

8. The process of claim 1, wherein both an inorganic coagulant and a flocculant are used in step (a).

9. The process of claim 8, wherein the inorganic coagulant comprises polyaluminum, and the flocculant comprises an anionic flocculant.

10. The process of claim 9, wherein the hydrophobicity modifying agent comprises dodecylamine.

11. The process of claim 10, wherein the inorganic coagulant is mixed with the tailings prior to mixing the tailings with the anionic flocculant.

12. The process of claim 1, wherein both a flocculant and a coagulant are used in step (a).

13. The process of claim 12, wherein the flocculant is mixed with the tailings prior to mixing the tailings with the coagulant.

14. The process as claimed in claim 13, wherein the flocculant comprises an anionic flocculant and the coagulant comprises a cationic polymeric coagulant.

1. 5. The process as claimed in claim 14, wherein the hydrophobicity modifying agent comprises dodecylamine.

16. The process of claim 1, wherein two different flocculants and a coagulant are used in step (a)

17. The process of claim 12, wherein the flocculant comprises an anionic polymeric flocculant.

18. The process of claim 17, wherein the dosage of the flocculant ranges from between about 0 to about 1500 grams per tonne of solids in the tailings.

19. The process of claim 12, wherein the flocculant comprises a polyacrylamide.

20. The process of claim 19, wherein the polyacrylamide has a molecular weight ranging between about 10 to about 24 million, and about 25-30% anionicity.

21. The process of claim 12, wherein the flocculant comprises guar gum, gelatin, an alginate, chitosan, or isinglass.

22. The process of claim 6, wherein the coagulant comprises a cationic polymeric coagulant.

23. The process of claim 22, wherein the dosage of the coagulant ranges between about 0 to about 1000 grams per tonne of solids in the tailings.

24. The process of claim 23, wherein the coagulant comprises polydimethyldiallylammonium chloride (polyDADMAC).

25. The process of claim 24, wherein the polyDADMAC has a molecular weight ranging from about 6,000 to about 1 million.

26. The process of claim 25, wherein the polyDADMAC has a cationicity of about 100%.

27. The process of claim 6, wherein the coagulant comprises an inorganic cationic coagulant.

28. The process of claim 27, wherein the inorganic cationic coagulant comprises alum, aluminum chlorohydrate, aluminum sulphate, lime, slaked lime, calcium chloride, magnesium chloride, iron (II) sulphate, iron (III) chloride, sodium aluminate, gypsum, or any combination thereof.

29. The process of claim 6, wherein the hydrophobicity modifying agent comprises dodecylamine.

30. The process of claim 1, wherein liquid solids separation is conducted in a gravity thickener, a hydrocyclone, a centrifuge, a vacuum filter, or a filter press.

31. The process of claim 1, wherein liquid solids separation is conducted using a filter press at a pressure of about 15.5 bar or less.

32. The process of claim 1, wherein the solids product comprises greater than about 50.0 wt % solids.

33. The process of claim 31, wherein the liquid product comprises about 1.0 wt % solids or less.

34. The process of claim 1, wherein the tailings are fluid fine tailings.
